(19) United States
(12) Patent Application Publication
(10) Pub. No.: US 2016/0039719 A1
(43) Pub. Date: Feb. 11, 2016

(54) ZIRCONIA BASED COATING FOR REFRACTORY ELEMENTS AND REFRACTORY ELEMENT COMPRISING OF SUCH COATING

(71) Applicant: James Ovenstone, Suzhou (CN)

(72) Inventor: James Ovenstone, Suzhou (CN)

(73) Assignee: VESUVIUS CRUCIBLE COMPANY, Wilmington, DE (US)

(21) Appl. No.: 14/776,593

(22) PCT Filed: Mar. 12, 2014
(86) PCT No.: PCT/EP2014/054807

§ 371 Date: Sep. 14, 2015

(30) Foreign Application Priority Data
Mar. 14, 2013 (EP) 13159206.5

(51) Int. Cl. C04B 35/48; B22D 41/14; B22D 41/50

(52) U.S. Cl. CPC C04B 35/481; B22D 41/50; B22D 41/14

(57) ABSTRACT

A coating composition for applications at temperatures higher than 1200 degrees C. comprises (a) between 80.0 and 99.9 wt. % of unstabilized zirconia; and (b) between 0.1 and 5.0 wt. % of a liquid phase former which is solid at ambient temperature and either melts or reacts, or decomposes to form a liquid phase above a temperature not lower than 1000 degrees C.; wherein the wt. % are expressed in terms of total solid weight of the coating composition at room temperature. A refractory element that may be made of a carbon bonded refractory comprises a coated surface comprising a first coating of the coating composition as defined above.

### BACKGROUND OF THE INVENTION

(1) Field of the Invention

The present invention relates to carbon bonded refractory elements in continuous metal casting installations. In particular, it concerns such elements comprising a surface coated with a zirconia based coating which is resistant to erosion, corrosion, cracking and chipping in use.

(2) Description of the Related Art

In metal forming processes, molten metal is transferred from one metallurgical vessel to another, then to a mould or to a tool. For example, as shown in FIG. 1 a ladle (100) is filled with a metal melt out of a furnace and transferred to a tundish (200). The molten metal can then be cast from the tundish to a continuous casting mould (300) for forming slabs, blooms, billets or other type of continuously cast products or to ingots or other discrete defined shapes in foundry moulds. Flow of metal melt out of a metallurgic vessel is driven by gravity through various nozzle assemblies (101, 101 in, 101 out, 111, 111 in, 111 out) located at the bottom of such vessels. The metal flow through the outlet nozzle of the tundish can be controlled by a stopper (20). Molten metal and, in particular, slag formed at the surface thereof by reaction of molten metal with casting powders form an aggressive environment at elevated temperatures for the refractory materials used in casting installations.

Zirconia based coatings have been applied on surfaces of refractory parts to enhance resistance to erosion and corrosion in the steel and glass industries. For example, WO1997043460 and Saito et al., J. Tech. Assoc. Refract. Japan, 20, (1) (2000), 53 disclose ceramic parts being coated with unstabilized zirconia (ZrO₂) for use in furnaces and nozzles in metal casting applications. Zirconia, however, undergoes a phase change from a monoclinic to a tetragonal crystal lattice at temperatures of about 1173° C. resulting in a significant and sudden volume reduction, which generates important stresses leading to cracks formation and peeling of the coating.

Zirconia can be doped with e.g., yttria, calcium oxide or magnesium oxide, at given concentrations to form a so-called (partially) stabilized zirconia which does not show a phase transformation between 1000 and 1500° C. Coating or refractory compositions comprising (partially) stabilized zirconia are disclosed e.g., in SU710782, JP11012035, JP9241085. Despite their good performance and absence of a phase change during heating to service temperatures above 1200° C., the stabilized materials still do not have the resistance to steel slags that the pure monoclinic materials possess. This is due to the stabilizing agent (calcia, yttria, magnesia, etc.) leaving the lattice to react with the components of the steel slag. This again results in a significant volume change in the zirconia crystals on a local scale, resulting in crack formation in the coating and debris being washed away by the steel/slag erosion.

WO97/43460 discloses ceramic or metal furnace fixtures clad on a surface thereof by an impermeable top layer of thermally deposited unstabilized zirconia. The unstabilized zirconia is thermally sprayed onto the substrate. Thermal spraying techniques are coating processes in which melted (or heated) materials are sprayed onto a surface. The “feedstock” (coating precursor) is heated by electrical (plasma or arc) or chemical means (combustion flame). In particular; plasma spraying is used to produce such coated fixtures. In plasma spraying, the material to be deposited (feedstock), typically as a powder, is introduced into a plasma jet emanating from a plasma torch. In the jet, where the temperature is of the order of 10,000 K, the material is melted and propelled towards a substrate. There, the molten droplets flatten, rapidly solidify and form a deposit. The deposits consist of a multitude of pancake-like lamellae called ‘splats’, formed by flattening of the liquid droplets. As the feedstock powders typically have sizes from micrometers to above 100 micrometers, the lamellae have thickness in the micrometer range and lateral dimension from several to hundreds of micrometers. Between these lamellae, there are small voids, such as pores, cracks and regions of incomplete bonding. As a result of this unique structure, the deposits can have properties significantly different from bulk materials (cf. http://en.wikipedia.org/wiki/Plasma_spray). WO03/099739, discloses a coating composition comprising unstabilized zirconia and fused silica applied as marking on ceramic materials, such as silicon carbide or silicon nitride followed by firing for sintering the material. By their composition (amounts above 10 wt. % of silica) and by their low thickness, such coatings are not suitable for applications in continuous casting equipment, wherein the coating is in contact with flowing metal melt at temperatures of the order of 1500° C. and higher.

U.S. Pat. No. 4,319,925 discloses a refractory mould coating for metal moulds used in casting iron, steel and other alloys. Said coating comprises unstabilized zirconia and colloidal silica. Again, the composition of such coatings with above 10 wt. % silica makes them unsuitable for applications at high temperature exposed to erosion. Furthermore, coating a surface of a metal mould is quite easier than coating a surface of a carbon bonded ceramic element.

There thus remains in the field of carbon bonded refractory elements in continuous casting installations a need for a temperature resistant coating enhancing the resistance to erosion of parts surfaces such as stopper noses, nozzle bores, sleeves, and the like. The present invention proposes coating compositions particularly suitable for enhancing considerably corrosion and erosion resistance of carbon bonded refractory ceramic elements used in continuous casting installations. These and other advantages of the present invention are presented in continuation.

### BRIEF SUMMARY OF THE INVENTION

The present invention is defined in the appended independent claims. Preferred embodiments are defined in the dependent claims. In particular, the present invention concerns a coating composition for applications at temperatures higher than 1200° C. comprising:
(a) between 80.0 and 99.9 wt. % (or from and including 80.0 wt. % to and including 99.9 wt. %) of unstabilized zirconia;
(b) between 0.1 and 5.0 wt. % (or from and including 0.1 wt. % to and including 5.0 wt. %) of a liquid phase former which is solid at ambient temperature and either melts or reacts, or decomposes to form a liquid phase above a temperature not lower than 1000° C.; wherein the wt. % in (a) and (b) are expressed in terms of total solid weight of the coating composition at room temperature (i.e., excluding water), and
(c) between 8 and 25 wt. % (or from and including 8 wt. % to and including 25 wt. %) of solvent with respect to the total weight of the composition including the solvent.

Suitable solvent may be water, methanol, ethanol, isopropyl alcohol or mixtures thereof. Other suitable solvent could also be considered. Water is not expensive and is particularly suitable for the application of the present coating onto a refractory element. Water is a thinning agent to allow spreading by dipping, brushing or other means. For coating a surface of a refractory material, the composition preferably comprises water to form a paste, preferably between 8 and 25 wt. % (or from and including 8 wt. % to and including 25 wt. %), of water, more preferably between 10 and 20 wt. % (or from and including 10 wt. % to and including 20 wt. %) of water, even more preferably, between 12 and 16 wt. % (or from and including 12 wt. % to and including 16 wt. %) water. Once applied onto a surface of a refractory element, the coating is dried to eliminate water, and/or fired. If not fired, before use, the coating portions entering in contact with high temperature metal melt or slag undergoes in use a local firing sequence in-situ.

The liquid phase former may be selected among silica, preferably fused silica, and aluminosilicate clay, in particular kaolinitic clay. The liquid phase former is preferably present in an amount comprised between 0.5 and 4.5 wt. % (or from and including 0.5 wt. % to and including 4.5 wt. %), more preferably between 1.5 and 3.5 wt. % (or from and including 1.5 wt. % to and including 3.5 wt. %). It is preferably present at room temperature in the form of a fine powder not coarser than 50 mesh (US) (≅297 μm), preferably, not coarser than 100 mesh (US) (≅149 μm).

The unstabilized zirconia is preferably present in an amount between 85.0 and 99.0 wt. % (or from and including 85.0 wt. % to and including 99.0 wt. %), preferably between 90.0 and 98.0 wt. % (or from and including 90.0 wt. % to and including 98.0 wt. %); more preferably between 91.0 and 96.0 wt. % (or from and including 91.0 wt. % to and including 96.0 wt. %). At room temperature it is preferably in the form of a monoclinic zirconia powder not coarser than 100 mesh (US) (≅149 μm), preferably not coarser than 200 mesh (US) (≅74 μm) and more preferably not coarser than 500 mesh (US) (≅31 μm).

The coating composition of the present invention preferably comprises additives selected among:

(a) a low temperature binder such as an organic binders, preferably present in an amount comprised between 0.1 and 5.0 wt. % (or from and including 0.1 wt. % to and including 5.0 wt. %) and selected from starch, gelatine, and carboxymethyl cellulose (CMC);
(b) a water proofing agent, such as polymeric emulsions (e.g., Primal), preferably present in an amount comprised between 0.1 and 5.0 wt. % (or from and including 0.1 wt. % to and including 5.0 wt. %);
and/or
(c) a rheology control additives like montmorillonite clays, such as bentonite, preferably present in an amount comprised between 0.1 and 0.8 wt. % (or from and including 0.1 wt. % to and including 0.8 wt. %);
wherein the wt. % are expressed in terms of total solid weight of the coating composition at room temperature.

The present invention also concerns a refractory element of a metal casting installation comprising a coated surface which comprises a first coating of composition as defined supra and which was applied by spraying, rolling, brushing, or dipping. The term “spraying” used alone refers herein to a coating process wherein a suspension or dispersion contained in a pressurized container is released in a fine mist through an appropriate nozzle and thus projected against a surface to be coated. This term used alone does not encompass alternative coating processes referred to by combined expressions comprising the term “spraying” (or derivatives thereof) such as “thermal spraying”, “plasma spraying”, “detonation spraying”, “wire arc spraying”, “flame spraying”, “high velocity oxy-fuel coating spraying (HVOF)”, “warm spraying”, “cold spraying”, and the like, which clearly differ from “spraying” used alone as defined above, at least in that the coating material is not in the form of a suspension or dispersion when sprayed.

In particular, the coated surface is preferably made of a carbon bonded material, such as zirconia, magnesia or alumina carbon bonded materials. The refractory element and coated surface are preferably one or more of these devices:

(a) a pouring nozzle comprising a sleeve and the coated surface is the external surface of said sleeve and/or extends along the interfaces between sleeve and outer surface of the pouring nozzle;
(b) a nozzle and the coated surface is at least a portion of the bore of such nozzle or at least a portion of an external surface thereof designed to be, in use, in contact with slag;
(c) a stopper and the coated surface is at least a portion of the nose of the stopper, and/or at least a portion of an outer surface of the stopper designed to be, in use, in contact with slag; or
(d) an inner nozzle comprising an inner nozzle seat suitable for cooperating with a stopper, and the coated surface is at least a portion of the inner nozzle seat.

The first refractory coating can be present on the coated surface as a wet paste, directly after application, as a dry coating after drying and elimination of most solvent such as water present in the originally wet paste, or as reaction product of firing a dried first coating at a temperature of at least 800° C., said fired first coating comprising between 90.0 and 96.0 wt. % (or from and including 90.0 wt. % to and including 96.0 wt. %) of unstabilized zirconia and between 0.1 and 4.5 wt. % (or from and including 0.1 wt. % to and including 4.5 wt. %) of a liquid phase former.

In a preferred embodiment, the refractory element has been fired together with the first coating and wherein the refractory element is preferably one of these devices:

(a) a ladle shroud and the coated surface is at least a portion of the bore of such shroud or at least a portion of an external surface thereof designed to be, in use, in contact with slag;
or
(b) a stopper and the coated surface is at least a portion of the nose of the stopper and/or an outer surface thereof designed to be, in use, in contact with slag.

In a preferred embodiment, a glaze coating is applied in a location directly on top of the first coating which acts as a primer to promote adhesion of the glaze to the substrate. The glaze coating may also be applied in a location directly below the first coating, which acts as a protective layer for the glaze.

Porosity of the first coating may be increased by various ways. First, the coating composition may comprise a monoclinic zirconia powder comprising a monoclinic zirconia powder having a granulometry comprising a fine fraction with grains not coarser than 100 mesh (US) (≅149 μm), preferably not coarser than 200 mesh (US) (≅74 μm), most preferably not coarser than 325 mesh (US) (≅44 μm) and a coarse fraction coarser than 70 mesh (US) (≅210 μm). The coarse fraction can also comprise partially stabilised zirconia, provided at least 80 wt. % of zirconia is unstabilized. If present in small amounts of the order of less than 10 wt. % (or from and including 0.1 wt. % to and including 10 wt. %), preferably less than 5 wt. % (or from and including 0.1 wt. % to and including 5 wt. %), the presence of partially stabilized coarse zirconia grains is not detrimental to the properties of the coating. If a higher porosity is desired, the zirconia particles of the coarse fraction can be coated with a material burning or volatilizing at a temperature below 800° C., preferably at a temperature below 500° C. Alternatively, or additionally, the coating composition may further comprise fine particles of a material burning or volatilizing at a temperature below 800° C., preferably at a temperature below 500° C., said particles preferably having a fibrillar geometry.

A first coating according to the present invention preferably has a thickness after drying or firing comprised between 0.1 and 20.0 mm (or from and including 0.1 mm to and including 20.0 mm), preferably between 0.1 and 5.0 mm (or from and including 0.1 mm to and including 5.0 mm), more preferably between 0.3 and 3.5 mm (or from and including 0.3 mm to and including 5.0 mm), most preferably between 0.5 and 2.0 mm (or from and including 0.5 mm to and including 2.0 mm).

### BRIEF DESCRIPTION OF THE SEVERAL VIEWS OF THE DRAWINGS

For a fuller understanding of the nature of the present invention, reference is made to the following detailed description taken in conjunction with the accompanying drawings in which:

FIG. 1: shows schematically a typical continuous casting line.

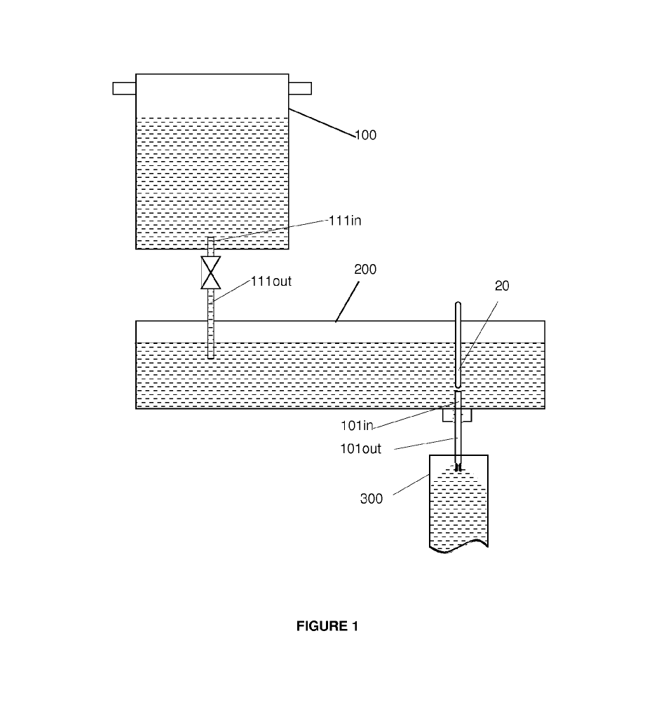

FIG. 2: shows a side cut of a submerged nozzle of a ladle with coating of the wall of the bore thereof (a) over the surface of an inner sleeve and (b) over the whole surface of the bore wall.

FIG. 3: shows a side cut of a stopper over (a) an inner nozzle of a tundish and (b) a submerged one piece pouring nozzle.

FIG. 4: shows a side cut of a submerged pouring nozzle of a tundish with a coating applied on different zones and having (a) lateral outlets and (b) axial outlets.

FIG. 5: shows various embodiments of coating sequences including a first coating according to the present invention.

### DETAILED DESCRIPTION OF THE INVENTION

A first coating according to the present invention is based on a composition comprising
(a) unstabilized zirconia present in an amount comprised between 80.0 and 99.9 wt. % (or from and including 80.0 wt. % to and including 99.9 wt. %), preferably between 85.0 and 99.0 wt. % (or from and including 85.0 wt. % to and including 99.0 wt. %), more preferably between 90.0 and 98.0 wt. % (or from and including 90.0 wt. % to and including 98.0 wt. %); most preferably between 91.0 and 96.0 wt. % (or from and including 91.0 wt. % to and including 96.0 wt. %);
(b) a liquid phase former present in an amount comprised between 0.1 and 5.0 wt. % (or from and including 0.1 wt. % to and including 5.0 wt. %), preferably between 0.5 and 4.5 wt. % (or from and including 0.5 wt. % to and including 4.5 wt. %), more preferably between 1.5 and 3.5 wt. % (or from and including 1.5 wt. % to and including 3.5 wt. %); wherein the wt. % in (a) and (b) are expressed in terms of total solid weight of the coating composition at room temperature (i.e., excluding water and other liquid phases at room temperature), and
(c) between 8 and 25 wt % (or from and including 8 wt. % to and including 25 wt. %) of solvent with respect to the total weight of the composition including the solvent.

A liquid phase former is a material, which is typically solid at ambient temperature and which, when heated to a threshold temperature, either melts or reacts, or decomposes to form a liquid phase above the threshold temperature. The liquid phase may or may not be retained upon cooling. In the frame of the present invention, the threshold temperature is not lower than 1000° C. and not higher than 1170° C., since phase transformation of zirconia from monoclinic to tetragonal occurs at around the latter temperature. For the present invention it is further preferred that the liquid phase former be a transient liquid phase former, which is defined as a liquid phase former, wherein the liquid phase reacts upon further heating to form further solid and gaseous phases and over time the liquid is removed, leaving behind only a new solid. Examples of liquid phase formers include silica, which can be incorporated into the composition as fused silica or colloidal silica, or aluminosilicate clay, in particular kaolinitic clay. At room temperature the liquid phase former is preferably in the form of a powder, dry or in a suspension, not coarser than 50 mesh (US) (≅297 μm), preferably not coarser than 100 mesh (US) (≅149 μm).

In a preferred embodiment, the liquid phase former performs a second function upon increasing the temperature, which is to facilitate the sintering of the zirconia grains so that they can form a continuous network bonded to and protecting the substrate. In such embodiment, the chemistry of the liquid phase is controlled to not only be liquid in the correct temperature range, but also to act as a transient liquid flux for the sintering of the zirconia. Care must be taken to limit the quantities of such flux to prevent zirconia itself from being contaminated, which would reduce its corrosion resistance. Therefore the liquid phase should be sufficient in quantity to absorb the stresses of the volume change during the phase change of zirconia; persistent enough to exist throughout the various thermal cycles before actual steel casting begins; viscous enough to allow retention of overall structural integrity of the coating during this period; reactive enough to aid sintering of the monoclinic zirconia as steel temperatures are approached, but without significantly reacting with the bulk of the zirconia; and finally transient enough to leave the zirconia coating as casting continues so that the first coating (1) becomes richer in unstabilized zirconia as casting proceeds and manifests high erosion/corrosion resistance. Colloidal silica and fused silica can be used as transient liquid phase former useful in the foregoing embodiment.

The unstabilized zirconia is preferably in the form of a fine powder of monoclinic zirconia, preferably not coarser than 100 mesh (US) (≅149 μm), more preferably not coarser than 200 mesh (US) (≅74 μm), most preferably not coarser than 325 mesh (US) (≅44 μm). In some cases, in particular if the first coating is to be fired together with the refractory element it is applied upon, some porosity is required to allow degassing of the refractory substrate. In one embodiment, the zirconia comprises a fine fraction not coarser than 100 mesh (US) (≅149 μm) and a coarse portion coarser than 70 mesh (US) (≅210 μm). Such embodiment is discussed more in details below.

A coating composition according to the present invention may comprise additives. For example it may comprise a low temperature binder such as an organic binder selected from starch, gelatine, and carboxymethyl cellulose (CMC). The organic binder will get lost during heating of the coating, either during firing of the coated refractory element or, alternatively, if the first coating is applied to the refractory element after firing of the latter, upon contact of the first coating with high temperature metal melt or during initial preheat during use. A low temperature organic binder enhances workability and cohesion of the coating composition for the coating of a surface. Another additive is a water proofing agent such as polymeric emulsions. An example is Primal available from Dow Chemicals. Rheology control additives like calcined alumina, clay, in particular montmorillonite clay such as bentonite are useful to adapt the viscosity of the composition to the coating technique utilized. A wetting agent, such as Surfonyl, can be useful to stabilize the aqueous composition and enhance adhesion to the surface to be coated.

In all cases, the components of a coating composition of the present invention comprise a solvent when the coating composition is applied to a surface of a refractory element. It must comprise between 8 and 25 wt % (or from and including 8 wt % to and including 25 wt %) of solvent with respect to the total weight of the composition (including solvent), preferably between 10 and 18 wt. % (or from and including 10 wt. % to and including 18 wt. %), more preferably between 12 and 15 wt. % (or from and including 12 wt. % to and including 15 wt. %). The solvent is preferably water or a water based solvent, water being preferred. These amounts include any aqueous medium present in components of the composition, such as for example in case colloidal silica is used, polymeric emulsion, etc. Once the first coating is applied onto a surface of a refractory element, the solvent such as the water must be eliminated. This can be done by firing the first coating together with the carbon bonded element it is applied onto or, when this is not possible, by drying the coating at room temperature or at elevated temperature lower than 200° C. It is clear that more time and energy is consumed to dry a coating applied with a high content of solvent (or a high content of water). On the other hand, insufficient solvent and/or water may lead to insufficient spreadability of the coating. The first coating can be applied onto a surface of a refractory element in any manner known in the art. In particular, a coating is applied by spraying, rolling, brushing, or dipping.

In many applications, the first coating is applied to a surface of a carbon bonded ceramic which has already been through its firing cycle during the manufacture thereof. This is the most common route followed by most manufacturers. To achieve a fired product the products are put in firing saggers, which are commonly made from steel. The purpose of the sagger is to protect the carbon bonded ceramic pieces from oxidation. During firing significant dimensional changes can occur, and so after firing it is common for pieces to be machined to their final dimensions before the application of a first coating (1) and optionally of a final glaze (2). Because of the machining of the pieces following firing thereof, it is therefore only possible to apply the first coating (1) and optional glaze (2) after firing of the pieces. Since the first coating of the present invention is advantageously applied to areas of a carbon bonded ceramic element which are to contact metal melt or slag at high temperatures above 1200° C., often above 1500° C., the coating will be fired during use by thermal contact with the metal melt or slag. Thanks to the presence of a liquid phase former, the volume changes undergone by zirconia during phase transformation from monoclinic to tetragonal are “absorbed” by the liquid phase.

For some products, however, the final dimension tolerances are larger, and so it is possible to avoid machining. This opens the opportunity to ‘open firing’, or essentially firing the piece without a sagger. This offers significant cost saving. Examples of pieces which may require no machining include ladle shrouds (111out) and stoppers (20). For pieces of these types, it would be possible to apply the first coating (1) and optional glaze (2) before firing the refractory element. Application of the first coating (1) and optional glaze (2) in itself is no different to that described above, however, during firing carbon bonded ceramics may degas significantly as volatile components are released at a significant rate during the process. This rapid evolution of gas can blow the first coating (1) off from the substrate surface, rendering both first coating and overlying glaze useless, and resulting in the scrapping of the piece. The glaze (2) alone does not present a problem to degassing of the carbon bonded ceramic during firing thereof because glazes (2) are a little fluid at the degassing temperatures and can allow gasses to pass out through the glaze, while the zirconia coating is not porous enough, and so may trap the gasses under pressure.

In a preferred embodiment of the invention, the composition of the present invention is adjusted to control the porosity of the first coating (1) during firing thereof and thus accommodate the issue of degassing of a carbon bonded ceramic. There are a number of alternative or complementary solutions that can be implemented:

(1) a proportion of the fine grain monoclinic zirconia can be replaced by a coarser grain zirconia material. Preferably, between 2 and 50 wt. % (or from and including 2 wt. % to and including 50 wt. %) of the zirconia material is coarser grain, more preferably between 5 and 20 wt. % (or from and including 5 wt. % to and including 20 wt. %). As discussed supra, when the fine grain zirconia may have a mean grain size not coarser that 100 mesh (US) (≅149 μm), the coarse grain zirconia may have a mean grain size of at least 50 mesh (US) (≅297 μm). The coarse grains act as defects not only in the coating allowing gas channels to form, but also result in thin spots on the overlying glaze, which also more freely pass the released gas. These defects do not affect the chemistry of the coating at high temperature, and are sealed by the formation of the liquid phase;
(2) If the degassing channels generated by the coarse grain are insufficient, the coarse grains can be pre-coated in a low temperature burning/melting material, before mixing into the main coating materials. The first coating (1) can then be applied as discussed above. At the early stages of firing the low temperature burning material burns at a temperature lower than 800° C., preferably lower than 500° C., and is removed opening slightly larger gas release channels in the first coating, which allow the degassing of the substrate. Again at high temperature during application, the liquid phase can close these channels and the final coating chemistry is not adversely affected. The low temperature burning/melting material could for instance be a wax, or polymer coating. An example would be a coating of phenolic resin and methanol in a ratio of 1:1 coated at 1.5 wt. % on to the coarse zirconia particles;
(3) low temperature burning/melting fibres or other shaped particulate materials can be directly added to the coating material to directly increase the porosity, and create gas release channels through the coating or the glaze. A preferred material would be polymer fibres, preferably hydrophobic in nature, and between 5 mm and 15 mm in length (or from and including 5 mm in length to and including 15 mm in length) and 0.01 mm in diameter, such as polypropylene fibres. The fibres, or other low burning/melting particulate material are directly removed by heat at the early stages of the firing cycle at a temperature lower than 800° C., preferably lower than 500° C., opening up gas release channels in the coating, and allowing degassing at higher temperatures. Again, at the high application temperatures, the formation of liquid phase heals the gas release channels and prevents loss of performance in the coating. The fibres can be added in the range of 0.1 to 10 wt. % (or from and including 0.1 wt. % to and including 10 wt. %), preferably of 0.5-1.0 wt. % (or from and including 0.5 wt. % to and including 1.0 wt. %).

A first coating as defined in the present invention may be slightly porous. In certain cases some porosity may be desired to assist the transient liquid phase former in preventing formation of cracks in the coating. As discussed supra, the porosity and other important microstructural features can be controlled using the particle size and morphology of the constituent zirconia powders. Even fired first coatings (1) which are porous can efficiently protect the surface of a refractory element. The first coating (1) in actual use during casting at high temperatures is usually more porous than the first coating as applied wet and subsequently dried. Upon firing, the porosity will increase and also result in a network formation between the zirconia grains. This means that although the coating will act as a barrier, slag will be able to permeate through the coating to the substrate material, and react to some extent. The reaction results as previously known in the art in the creation of easily washed off corroded material. However, as the coating is still present on the outside of the coated surface of the refractory element, the corroded material is no longer exposed to the erosive forces normally present, and so remains in place. As the thickness of the corroded material increases, it forms a kind of passivation layer and the reaction rate decreases due to diffusion limited kinetics. As long as the porous first coating is not fully removed, the system remains in equilibrium. Therefore, the coating acts as a barrier, physically slowing the progress of corrosive slag to the substrate, and then as a ‘net’, holding corroded products in place.

In the invention, erosion resistant benefit can be derived from coatings not thinner than 0.3 mm after drying or firing, preferably not thinner than 0.75 mm, more preferably not thinner than 1.0 mm. Greater benefit will, however, be reaped from thicker coatings of up to 3.0 mm, 4.0 mm, and even 5.0 mm. Beyond this thickness, the risk of important thermal gradients through the thickness of the first coating may result in early failure of the coating upon exposure to metal casting temperatures.

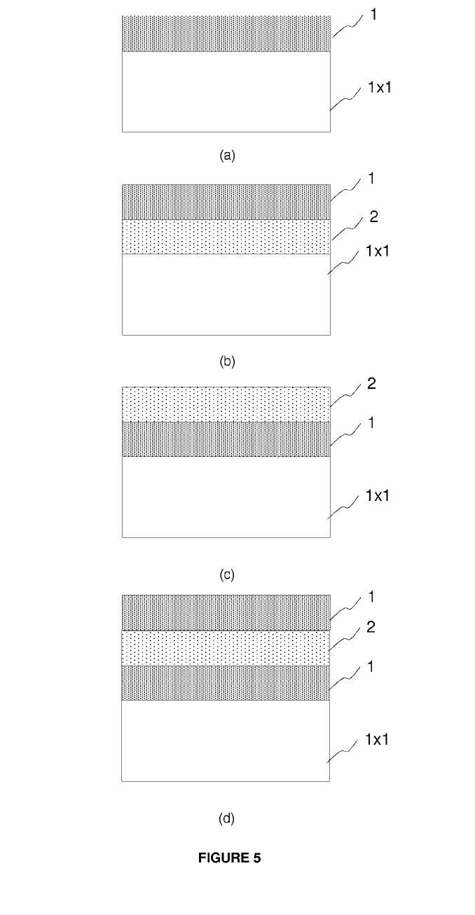

As illustrated in FIG. 5(a)&(c), a first coating (1) according to the present invention may be applied directly onto a surface of a carbon bonded ceramic element (101, 111), referred to in general as 1×1). As discussed supra a glaze (2) can be applied on top of the first coating which acts as primer as shown in FIG. 5(c)&(d). Traditional zirconia and magnesia carbon bonded ceramic mixes are well known to those versed in the art to be difficult to glaze. By this it is meant that due to the surface activity of the materials, it is difficult to apply a glaze (2) coating that will survive either firing during production and or preheating during use without forming defects, such as pinholes, which result in oxidation of the refractory and loss of service life. The first coating (1) of the present invention can provide a surface which is ideal for glazing, providing a good bond between the glaze (2) and the substrate (1×1), throughout the various thermal cycles that it endures, and at the same time not damaging the refractoriness of the body. This is accomplished through its chemistry for chemical bonding to the substrate and glaze and ideal porosity characteristics which give a good physical surface for the glaze to lock into. For example such primer is ideal for coating stopper noses (20n). Due to the nature of their use stopper noses (20n) suffer difficult conditions due to extreme thermal cycles during preheat and at the start of casting, and also often consist of difficult to glaze coarse materials such as carbon bonded magnesia. The resistance of a glaze coating (2) applied on the nose of a stopper (20) is enhanced through the application thereof on top of a first coating (1) according to the present invention used as a primer. In this application, a thin coating of 0.1-0.5 mm (or from and including 0.1\mm to and including 0.5 mm) is preferred.

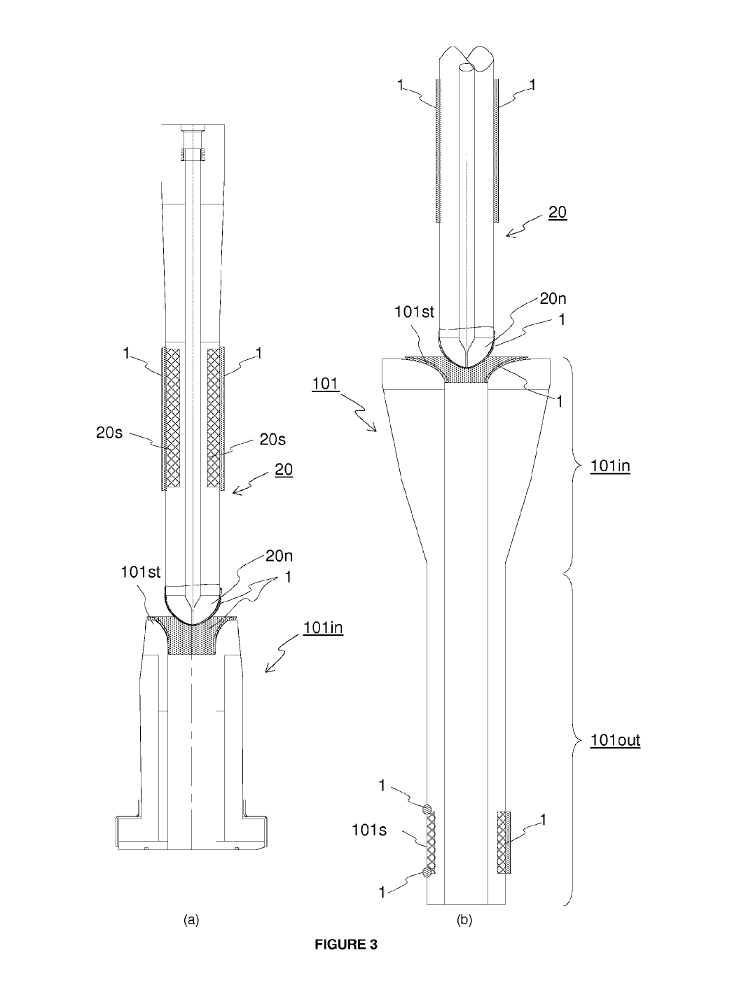

A first coating (1) may also advantageously be applied on top of a glaze coating (2) as shown in FIG. 5(b)&(d). This can be advantageous for example for coating a stopper nose (20n). As highlighted before, stopper noses go through difficult preheat conditions, which can result in the glaze melting. If at this point the stopper is put in the closed position in a tundish, there is a significant risk of the glaze (2) being removed from the stopper nose (20n). When the stopper (20) is then opened again later in the preheat, the nose can be left unprotected by glaze and thus oxidized, shortening service life, or resulting in catastrophic failure. A zirconia based first coating (1) on the outside of the glaze (2) can help to prevent this occurring by having a hard material with relatively small amounts of liquid phase available on the outside, preventing the glaze from being removed from the stopper nose. By the same method, the seat area (101st) of nozzles (101, 101in) can also benefit from a thin first coating (1) of the zirconia material to make a matched pair of refractory surfaces which do not melt and stick when they come into contact with each other as illustrated in FIG. 3(a)&(b).

An example of zirconia based composition according to the present invention is listed in Table 1 below.

TABLE 1
example of compositions of zirconia based
coating according to the present invention

| | | | wet | | |
|---|---|---|---|---|---|
| | | wet | (solid) | dry | fired |
| component | | wt. % | wt. % | wt. % | wt. % |
| unstabilized zirconia | 325 mesh (US) | 75.1 | 90.0 | 90.0 | 93.7 |
| | powder (≅44 μm) | | | | |
| liquid phase former | Colloidal silica | 6.5 | 2.3 | 2.3 | 2.4 |
| water proofing agent | Primal | 2.5 | 3.9 | 3.9 | 0.0 |
| rheology control | Calcined | 2.0 | 2.9 | 2.9 | 3.0 |
| agent | alumina | | | | |
| rheology control | Bentonite | 0.2 | 0.4 | 0.4 | 0.4 |
| agent | | | | | |
| rheology control | Attagel | 0.3 | 0.5 | 0.5 | 0.5 |
| agent | | | | | |
| wetting agent | Surfonyl | 0.3 | 0.0 | 0.0 | 0.0 |
| Water | | 13.1 | 0.0 | 0.0 | 0.0 |

| | | | | |
|---|---|---|---|---|
| Total | 100 | 100 | 100 | 100 |

The column “wet” indicates the weight percentage of each component comprising water in a paste composition ready for coating. The column “wet (solid)” refers to the same composition as in the preceding column in weight percentage with respect to the total solids weight (excluding added water and the aqueous phase in colloidal compositions). Note that the contents of the various components of a composition of the present invention are defined in the appended claims in terms of the total solids weight of the composition. The column “dry” gives the solids weight contents of the components of the same composition after drying for 24 h at a temperature of 80° C. As discussed above, this situation is quite common and is compulsory with refractory elements requiring machining after firing thereof. The last column “fired” gives the corresponding compositions after firing the coating for 1 h at a temperature of 1000° C. Firing of the first coating (1) may happen during firing of the coated refractory element, for those elements requiring no machining after firing or, more likely, in use upon contacting a dried first coating (1) with molten steel.

A composition such as listed in Table 1 can be advantageously used for coating a surface of a refractory element (101,111, 1×1) of a metal casting installation. The refractory element is preferably a carbon bonded refractory ceramic. A carbon bonded ceramic, as well known in the art is a specific type of refractory material characterized in that it contains grains of powders such as but not limited to alumina, zirconia, magnesia, SiAlON, zirconia, or mullite, mixed with elemental carbon in the form of graphite, or charcoal (or other forms), and bound together with a carbonaceous binder such as, but not limited to, resin (phenolic or otherwise), pitch, or some other. Carbon bonded refractories are typically used in metal casting as pieces formed by pressing into specific shapes, such as nozzles, stoppers, and the like.

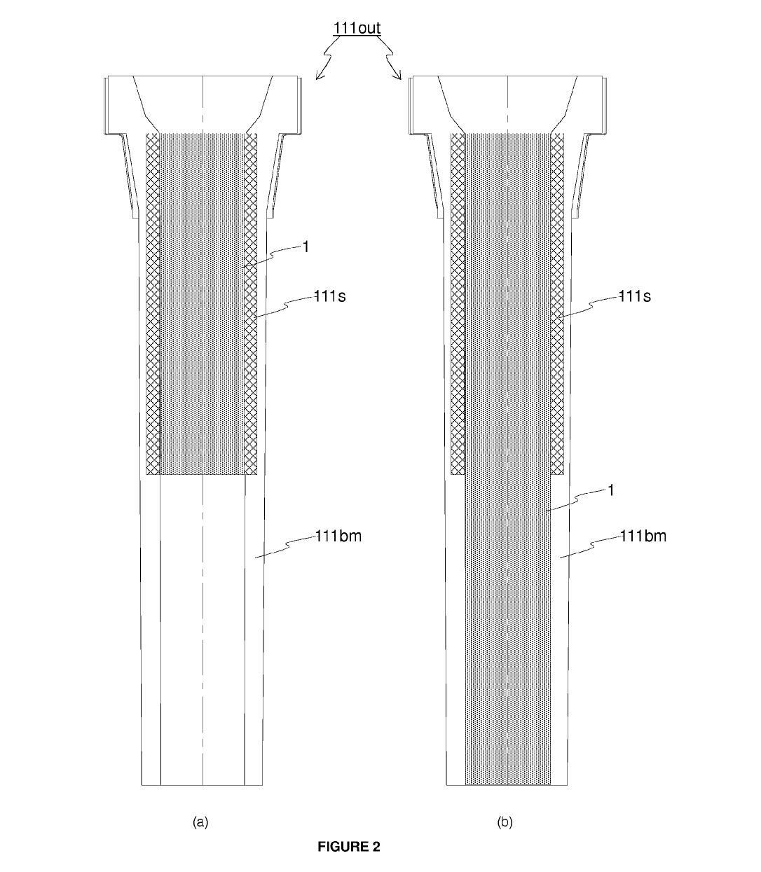

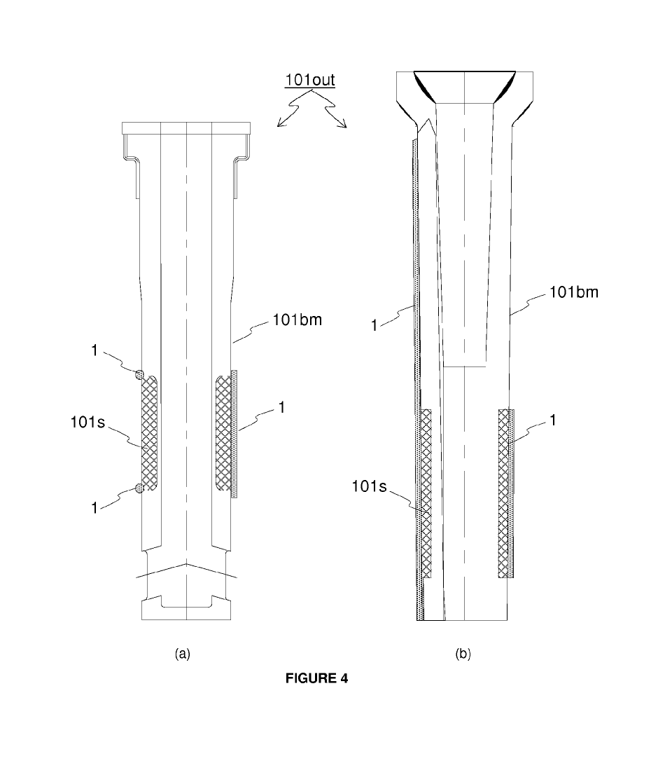

A coating composition according to the present invention is advantageously used for coating surfaces of carbon bonded refractory elements which are in contact with chemically corrosive environments, such as slags in steel casting, or as some aggressive steel grades, such as calcium treated steels, which may react with alumina graphite refractories forming low melting calcium aluminates, which then rapidly erode away. To increase the resistance to chemical corrosion of refractory elements, sleeves (101s, 111s) made of e.g., carbon bonded zirconia, are applied in areas of the nozzles which contact slag. Such sleeves are expensive and a less resistant and cheaper material can be used for the sleeves if coated with a first coating (1) according to the present invention (cf. FIGS. 2, 3(b), and 4). Even if a high resistance sleeve is used, the interface between the sleeve (101s, 111s) and the body mix (101bm, 111bm) exposed to the slag is a weak point. A first coating (1) ribbon running along such interface eliminates such weak point thus increasing substantially resistance to corrosion of an element (cf. FIGS. 3(b) and 4(a), left sides).

A coating composition according to the present invention can also advantageously be used for coating surfaces exposed to high physical erosion forces due for example to high steel melt flow rates. A good example includes stopper noses and nozzle seats. At the interface between stopper noses and nozzle seats, during casting, there is a region known as the throttling region. This is in effect the narrowest pathway that the liquid steel passes through, and is used to control the rate of casting. By definition then, the rate of steel flow past the refractory is highest at this point, and the erosion forces are highest in such region. Applying a first coating (1) at the nose (20n) of a stopper (20) and/or to the corresponding nozzle seat (101st, 111st) improves service life of such sensitive areas (cf. FIG. 3). Another example is of course the bore of a nozzle as illustrated in FIG. 2.

FIG. 2 shows two ladle submerged nozzles (or shrouds) (111out) comprising an internal sleeve (111s) for reducing clogging problems. Clogging is a common problem with the casting of many steel grades, and is related to the build-up of alumina and other re-oxidation products in the bores of nozzles; this concerns both ladle nozzles (111out) and tundish nozzles (101out). Clogging of the bore presents two types of problems:

(1) If the clogging continues unabated, then eventually the bore of the nozzle closes, and casting must stop, shortening the sequence, and raising the cost of the resulting steel;
(2) If the clogging material periodically flushes, then large amounts of detritus material (mainly alumina) fall into the mould, contaminating the steel in the form of inclusions, and causing numerous defects, reducing the steel quality, and its value.
There are a number of strategies used to combat clogging, including using sacrificial layers or low carbon mixes as liners for the bores of nozzles. These meet with varying levels of success depending on the conditions used in the steel plant and the type of steel being cast.

Within the ambit of the present invention, an alternative approach is proposed, of applying a first coating composition (1) of the present invention onto a portion of, or the whole surface of the nozzle bore wall as illustrated in FIG. 2(a)&(b). The first coating (1) is applied directly onto the body mix and/or onto the sleeve (111s). The first coating (1) creates a carbon free relatively dense inert layer on the bore surface which reduces the air ingress through the walls of the refractory to the steel, thus reducing re-oxidation of the steel. The lower porosity of the coating will also limit the migration of carbonaceous gases generated within the substrate at application temperature. It is important to limit their migration since such gases can otherwise be drawn into the steel flow to be reduced and can thus produce more alumina to clog. At the same time, the inert nature of the coating reduces the likelihood of the steel reoxidation products sticking to the bore and building up to a dangerous or problematic level, and so clogging can be greatly reduced, increasing refractory longevity and steel quality. In some applications, the sleeve is not necessary anymore, first coating alone being efficient to increase the shroud service life.

FIG. 3 illustrates a stopper (20) vis-à-vis (a) an inner nozzle (101in) and (b) an integral submerged pouring nozzle (101), wherein inner nozzle portion (101in) and outer nozzle portion (101out) are all integral in one piece. As discussed above, steel flow rate is highest at the throttling region, which is the passage between a stopper nose (20n) and the corresponding nozzle seat (101st), such that physical erosion rate is highest at that point. Depending on the steel grade being cast, stopper noses and nozzle seats can be made from different materials, including alumina graphite, magnesia graphite, or sintered zirconia inserts. For aggressive steel grades, such as calcium treated, alumina graphite is not appropriate as it can react with the calcium in the steel and form low melting calcium aluminates, which then rapidly erode away. In this case inserts made of zirconia or, more commonly of magnesia can be used in nozzle seats and stopper noses. These, however, are expensive and difficult to produce.

According to the present invention, a first coating (1) can be applied onto simple alumina graphite stopper noses (20n) or nozzle seats (101st), and protect the substrate from both physical erosion and chemical corrosion by the steel. This offers significant potential savings in cost and improvements in performance. The thickness of such first coatings is preferably comprised between 0.3 and 1.0 mm. The application of a first coating (1) of the present invention to stopper noses and nozzle seats is also advantageous because the first coating composition generally consists of fine grained zirconia. Traditionally, those skilled in the art use coarse grained zirconia, alumina, magnesia, or spinel to improve the longevity of carbon bonded ceramics, as the grain surface area to volume ratio is lower, thus reducing reactivity of coarse grains compared with finer grains. This also applies to the mixes used in long life stopper noses and nozzle seats. The downside is that when coarse grains are washed out of the carbon bonded ceramics, they are also too large to rapidly dissolve in the steel, and so are prone to cause cracks, slivers and other steel defects. By using a sintered first coating (1) of the present invention, composed of fine grained unstabilized zirconia, no coarse grains are washed into the steel, and so such steel defects can be avoided, improving the quality of the steel, and thus its value.

A portion of the shaft of a stopper (20) contacts slag as it is moved up and down, away and towards the nozzle seat (101st) of an inner nozzle. This may lead to rapid erosion and corrosion of the body mix constituting the shaft of the nose. For this reason, stoppers are sometimes provided with a sleeve (20s). This of course increases the cost of the stopper. Two options are possible. A coating composition (1) according to the present invention is applied on top of a sleeve (20s) of a stopper as shown in FIG. 3(a). This further increases the cost of the stopper, but also considerably increases the service life thereof. In an alternative option, a coating (1) is applied directly onto the body mix of the shaft of a stopper as shown in FIG. 3(b). This solution can yield service lives comparable with the ones obtained with a (uncoated) sleeve (20s) but at considerably lower cost. In summary, a metallurgist has the choice between (a) a low cost, unprotected stopper (20) with limited service life; (b) a slightly more expensive stopper (20) provided with a coating (1) of the present invention with considerably longer service life (cf. FIG. 3(b)); (c) a substantially more expensive stopper provided with a sleeve (20s) and no coating, yielding a service life comparable with the previous stopper (b); and (d) a stopper (20) provided with a sleeve (20s) and overcoated with a coating composition (1) of the present invention, at higher cost, which is largely compensated by a substantially longer service life.

FIG. 4 illustrates two submerged pouring nozzles (or shrouds) (101out) used to cast steel out of a tundish (a) into a continuous mould or (b) into an ingot. As illustrated in FIG. 4, sleeves (101s) often made of stabilized zirconia or magnesia are applied on the portion of the outer wall of the nozzle which contacts corrosive slag in use. As discussed in the introductory section, however, stabilized zirconia does not offer the same resistance to slag as unstabilized zirconia. In a preferred embodiment, a first coating (1) of the present invention is applied over the sleeve (101s) as shown on the right hand side of the nozzles of FIG. 4(a)&(b). Alternatively, a first coating (1) can be applied only over the interface between the sleeve (101s) and the body mix (101bm) of the nozzle (101out), since such interfaces are quite sensitive to corrosion (cf. left hand side of FIG. 4(a)). Finally, as illustrated on the left hand side of FIG. 4(b), a first coating (1) of the present invention may be applied over the whole external surface of the tubular section of the pouring nozzle (101out). This has the advantage of protecting the refractory body mix (101bm), generally made of an alumina based carbon bonded ceramic, from mould flux which often is blown around the casting floor and is very harmful to alumina based ceramics when it is blown up from the mould and onto the body mix where it attacks rapidly, potentially causing holing. A 0.1 to 0.5 mm (or from and including 0.1 mm to and including 0.5 mm) thick, preferably 0.2-0.3 mm (or from and including 0.2 mm to and including 0.3 mm) thick first coating (1) of the present invention substantially increases service time of pouring nozzles exposed to such mould flux.

The coating composition of the present invention can therefore benefit refractory pieces which are either preheated or not by extending the service life or cost of the slag line position by improving resistance to physical erosion and to chemical corrosion. The invention can also improve the oxidation resistance and thus service life of refractory pieces by providing a suitable surface for glaze application on otherwise difficult to glaze materials. The coating material also offers potential improvements in the performance of stopper noses and nozzle seats, particularly in the presence of aggressive steel grades, such as those which are calcium treated. The invention can be used to reduce steel defects caused by the deposit of coarse refractory particles into the steel flow, and also by reducing the clogging of the nozzles.

Numerous modifications and variations of the present invention are possible. It is, therefore, to be understood that within the scope of the following claims, the invention may be practiced otherwise than as specifically described.

I claim:

1-15. (canceled)

16. Coating composition for applications at temperatures higher than 1200° C. comprising:
(a) from and including 80.0 wt. % to and including 99.9 wt. % of unstabilized zirconia;
(b) from and including 0.1 wt. % to and including 5.0 wt. % of a liquid phase former which is solid at ambient temperature and either melts or reacts, or decomposes to form a liquid phase above a temperature not lower than 1000° C.;
wherein the wt. % in (a) and (b) are expressed in terms of total solid weight of the coating composition at room temperature, and
(c) from and including 8 wt. % to and including 25 wt. % of solvent with respect to the total weight of the composition including the solvent.

17. Coating composition according to claim 16, wherein the solvent is water.

18. Coating composition according to claim 16, wherein the liquid phase former is selected from the group consisting of silica, fused silica, aluminosilicate clays, and kaolinitic clay.

19. Coating composition according to claim 16, wherein the liquid phase former is present in an amount from and including 0.5 wt. % to and including 4.5 wt. %, wherein the wt. % are expressed in terms of total solid weight of the coating composition at room temperature.

20. Coating composition according to claim 16, wherein unstabilized zirconia is present in an amount from and including 85.0 wt. % to and including 99.0 wt. %.

21. Coating according to claim 18, wherein the unstabilized zirconia is present at room temperature as a monoclinic zirconia powder not coarser than 100 mesh (US) (≅149 μm).

22. Coating according to claim 18, wherein the liquid phase former is selected from the group consisting of fine silica not coarser than 50 mesh (US) (≅297 μm), and clay powder not coarser than 50 mesh (US) (≅297 μm).

23. Coating according to claim 16, further comprising an additive selected from the group consisting of a low temperature binder, an organic binder, starch, gelatin, carboxymethyl cellulose (CMC), a water proofing agent, a polymeric emulsion, a rheology control additive, montmorillonite clay, and bentonite.

24. Refractory element of a metal casting installation comprising a coated surface which comprises a first coating of a composition according to claim 16, wherein the coating surface is applied to the refractory element by a process selected from the group consisting of spraying, rolling, brushing and dipping.

25. Refractory element according to claim 24, wherein the coated surface is made from a material selected from the group consisting of a carbon bonded material, a zirconia carbon bonded material, a magnesia carbon bonded material, and an alumina carbon bonded material.

26. Refractory element according to claim 25, wherein the refractory element comprises a device selected from the group consisting of:
(a) a pouring nozzle having an outer surface and comprising a sleeve, wherein the coated surface extends along the interfaces between and the outer surface of the pouring nozzle;
(b) a nozzle having an external surface, wherein the coated surface is at least a portion of the external surface;
(c) a stopper having an outer surface, wherein the coated surface is at least a portion of the outer surface; and
(d) an inner nozzle comprising an inner nozzle seat configured to cooperate with a stopper, wherein the coated surface is at least a portion of the inner nozzle seat.

27. Refractory element according to claim 24, wherein the first coating comprises a fired first coating that is the reaction product of firing a composition according to claim 16 at a temperature of at least 800° C., wherein the fired first coating comprises from and including 90.0 wt. % to and including 96.0 wt. % of unstabilized zirconia and from and including 0.1 wt. % to and including 4.5 wt. % of a liquid phase former.

28. Refractory element according to claim 27, wherein the refractory element comprises a device selected from the group consisting of:
(a) a ladle shroud having an external surface, wherein the coated surface is at least a portion of the external surface; and
(b) a stopper having an outer surface, wherein the coated surface is at least a portion of the outer surface.

29. Refractory element according to claim 24, wherein the coated surface comprises a glazing coating composition applied in a location selected from the group consisting of directly on top of the first coating, and directly below the first coating.

30. Refractory element according to claim 27, wherein the fired first coating has an open porosity obtained by using a first coating composition comprising a material selected from the group consisting of:
(a) a zirconia powder having a granulometry comprising a fine fraction according to claim 20; and a coarse fraction coarser than 70 mesh (US) (≅210 μm);
(b) a zirconia powder having a granulometry comprising a fine fraction according to claim 20; and a coarse fraction coarser than 70 mesh (US) (≅210 μm), wherein the coarse fraction is coated with a material burning or volatilizing at a temperature below 800° C.;
(c) fine particles of a material burning or volatilizing at a temperature below 800° C.;
(d) fine particles of a material burning or volatilizing at a temperature below 800° C. and having a fibrillary geometry; and
(e) combinations of these materials.

31. Refractory element according to claim 24, wherein the first coating has a thickness from and including 0.1 mm to and including 20.0 mm.
